(19) United States
(12) Patent Application Publication
(10) Pub. No.: US 2010/0317243 A1
(43) Pub. Date: Dec. 16, 2010

(54) DEVICE CAPABLE OF TRANSLATIONAL MOVEMENT OVER A SURFACE

(76) Inventor: Betty Lee Snow, Auckland (NZ)

Correspondence Address: YOUNG & THOMPSON, 209 Madison Street, Suite 500, Alexandria, VA, 22314, US

(21) Appl. No.: 12/525,949

(22) PCT Filed: Feb. 4, 2008
(86) PCT No.: PCT/US08/52888

§ 371 Date: Aug. 5, 2009

(30) Foreign Application Priority Data
Feb. 5, 2007 (NZ) 553041

(51) Int. Cl. B63H 13/00; B63H 21/17; B60K 16/00; B60G 21/00

(52) U.S. Cl. 440/6; 440/8; 180/2.2; 280/29

(57) ABSTRACT

A device capable of translational movement has a base capable of movement across a ground surface or across or through a liquid surface. The base mounts one or more wind turbines aligned substantially horizontally in use, and a drive element operable to move the base. The drive element is powered directly or indirectly by the turbine or turbines. The turbine(s) are such that the turbine operates over at least a wide range of wind directions relative to the device. In the preferred form the turbines are spaced outwardly from the base so as to provide a vehicle space between the turbine or turbines and the base.

### TECHNICAL FIELD OF THE INVENTION

This invention relates to devices capable of translational movement over a surface such as vehicles, and particularly though not necessarily solely to vehicles able to move over water, and or jointly over water and land.

### BACKGROUND ART

Conventional wind powered watercraft use non-fixed means such as sails for manoeuvring. However, it is usually necessary to provide winches and lines on such sail boats which both cause obstruction on the deck to the user and also increase the weight of the boat.

Furthermore, often substantial skill or manpower is required to raise, lower, trim and otherwise operate the sails of such boats.

This is disadvantageous.

### OBJECT OF THE INVENTION

It is therefore an object of the present invention to provide a vehicle which will obviate or minimise the foregoing disadvantages in a simple yet effective manner or which will at least provide the public with a useful choice.

### STATEMENT OF THE INVENTION

Accordingly in one aspect the invention consists in a device capable of translational movement having a base capable of movement across a ground surface or across or through a liquid surface, said base mounting one or more wind turbines aligned substantially horizontally in use, and drive means operable to move said base, the drive means being powered directly or indirectly by said turbine or turbines, the turbine(s) being such that the turbine operates over at least a wide range of winds directions relative to the device.

Preferably said turbines are spaced outwardly in use from the said base.

Preferably said turbines provide electric power to a battery, the battery driving an electrically powered motor.

Preferably the turbines are mounted on an exoskeleton mounted above said hull or hulls.

Preferably the exoskeleton is shaped substantially in the form of a half cylinder.

Preferably the device comprises a vehicle.

Preferably said vehicle comprises a vessel.

Preferably said vessel comprises a marine vessel.

Preferably a plurality of turbines are mounted above the base.

Preferably said turbines are helical or helicoidal.

Alternatively said turbines are propeller driven.

Preferably said base comprises a hull or hulls.

Preferably there are two or three hulls.

Preferably pontoons are provided exterior of said turbines with respect to the hull or hulls to provide buoyancy in the event of the device overturning.

Preferably pontoons are provided across the hull or hulls adjacent fore and aft positions of the device.

Preferably if desired the base carries wheels to allow operation on land surfaces.

In a further aspect the invention consists in a device capable of translational movement having a base capable of movement across a ground surface or across or through a liquid surface said base mounting one or more wind turbines aligned substantially horizontally in use, and drive means operable to move said base, the drive means being powered directly or indirectly by said turbine or turbines, the turbine or turbines being space outwardly from the base so as to provide usable space between the turbine or turbines and the base.

Preferably said turbines provide electric power to a battery, the battery driving an electrically powered motor.

Preferably the turbines are mounted on an exoskeleton mounted above said hull or hulls.

Preferably the exoskeleton is shaped substantially in the form of a half cylinder.

Preferably the device comprises a vehicle.

Preferably said vehicle comprises a vessel.

Preferably said vessel comprises a marine vessel.

Preferably a plurality of turbines are mounted above the base.

Preferably said turbines are helical or helicoidal.

Alternatively said turbines are propeller driven.

Preferably said base comprises a hull or hulls.

Preferably there are two or three hulls.

Preferably pontoons are provided exterior of said turbines with respect to the hull or hulls to provide buoyancy in the event of the device overturning.

Preferably pontoons are provided across the hull or hulls adjacently fore and aft positions of the device.

Preferably, if desired, the base carries wheels to allow operation on land surfaces.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawings in which,

FIGS. 1 to 4 are side, top, bottom and rear views of a vehicle comprising a catamaran and exoskeleton according to a preferred embodiment of the invention,

FIGS. 5 and 6 are a side and front view of an alternative simple embodiment of the invention,

FIGS. 7 to 9 are front, side and perspective views of an alternative vehicle according to the invention,

FIG. 10 is a view as in FIG. 9 but showing an alternative turbine,

FIG. 11 is illustrative of a houseboat with protective enclosure according to an alternative embodiment of the invention.

FIG. 12 is illustrative of a vehicle according to a further preferred embodiment of the invention.

FIG. 13 is illustrative of a vehicle according to a still further preferred form of embodiment of the invention.

FIG. 14 is illustrative of a still further embodiment of the invention as a hovercraft,

FIGS. 15 to 18 are side, front, rear and plan views of a further alternative embodiment of the invention,

FIG. 19 is illustrative of a vehicle according to a still further preferred embodiment of the invention as a self-propelled transportable barge used as a wind-powered factory for the manufacture of wind turbines.

FIGS. 20 to 22 are perspective diagrammatic views of moveable recharging facilities forming a further embodiment of the invention,

FIG. 23 is a perspective view of a turntable forming a further embodiment of the invention,

FIG. 24 is a perspective view of a swingbridge forming a further embodiment of the invention,

FIG. 25 is a diagrammatic perspective view of a turbine capable of use in the invention,

FIG. 26 is a diagrammatic perspective view of an alternative turbine capable of use in the invention,

FIGS. 27 and 28 are a plan view and a side elevation of a road vehicle according to a preferred form of the invention,

FIGS. 29 and 30 are a plan view and a rear elevation of a tri-maran according to a preferred form of the invention, and

FIGS. 31 to 33 are a plan view, a side elevation and a rear elevation of a catamaran according to a preferred form of the invention.

### BEST MODE FOR CARRYING OUT THE INVENTION

Referring to the drawings a vehicle according to the invention is provided as follows.

The device capable of translational movement over a surface may be a marine vessel but could be for example a hovercraft or a vehicle which could move over land perhaps as a recreational vehicle on a beach. The device may also be other moveable structures as will be described further hereinafter.

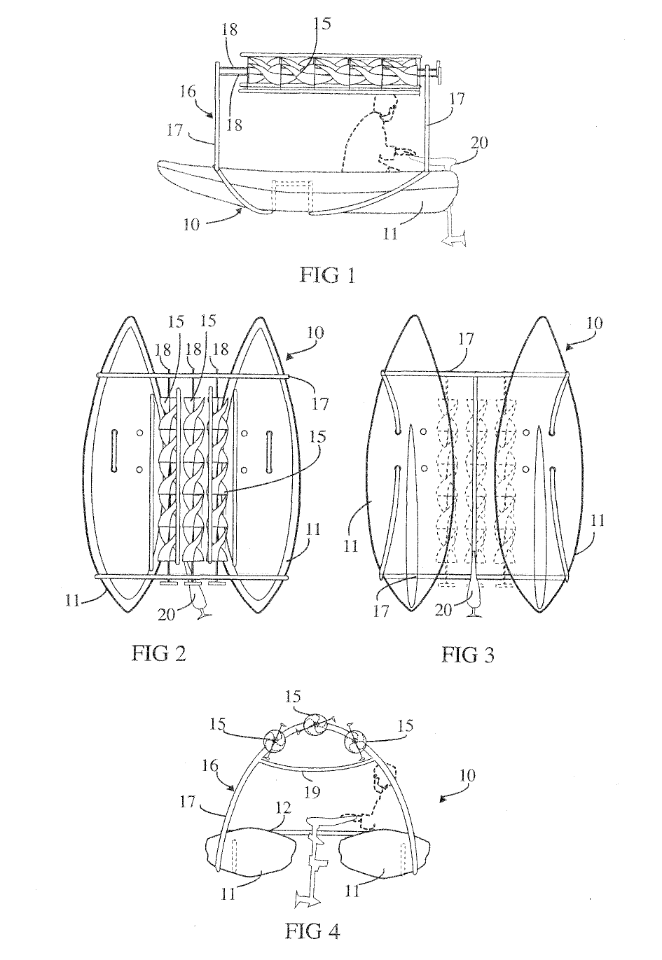

Referring to FIGS. 1 to 4 a vessel 10 is provided which is in the form of a marine vessel in particular a catamaran having a pair of hulls 11.

The hulls 11 can be spanned by a deck, platform, or more simple structure such as stringers 12. Thus the hulls 11 and the deck, platform or stringers 12 form a base for the vessel.

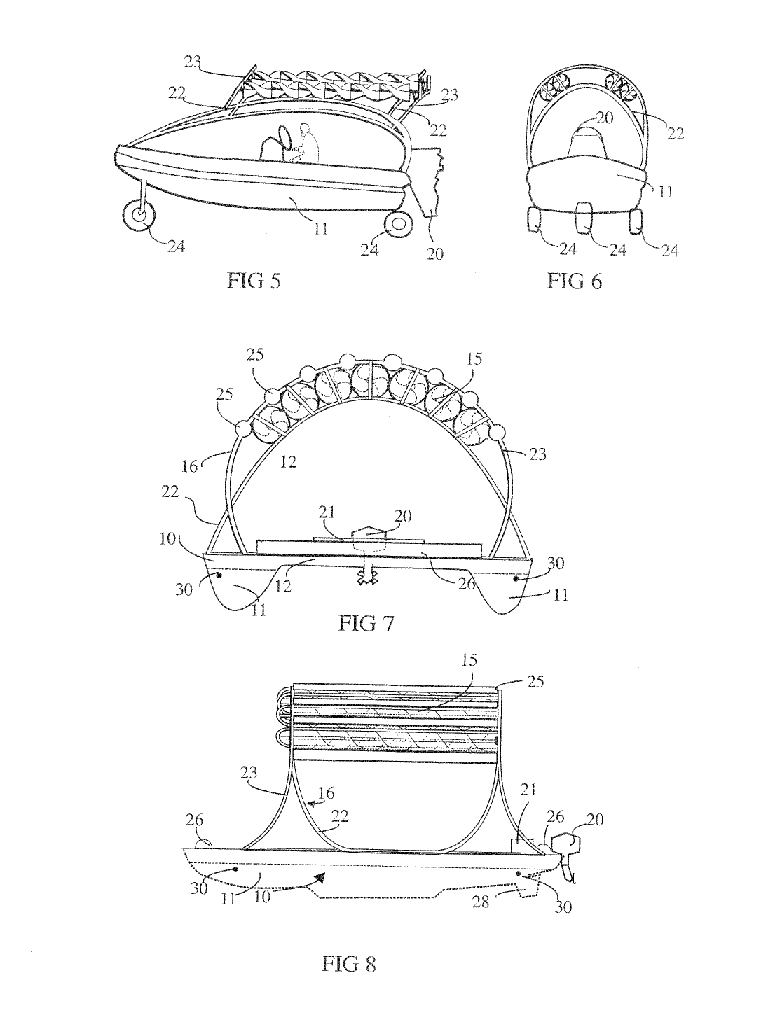

One or more wind turbines 15 are provided. In the embodiment of FIGS. 1 to 4 three turbines are shown but the exact number will be determined by the size and performance expectations of the vessel. The turbines 15 are aligned substantially horizontally in use and may, for example, be helical or helicoidal turbines. The turbines 15 are spaced from the base for example by being mounted on an exoskeleton 16 formed for example by the structures 22 and 23 may be braced by cross rods 31 a pair of spaced apart arch members 17 which carry the axles 18 of turbines 15. The arch members 17 may be braced by a bracing member 19. The vessel mounts a suitable electrically powered motor such as motor 20 which can be powered by batteries (not shown) but shown as batteries 21 in FIGS. 7 and 8. The batteries 21 are recharged by the electrical power generated by the turbines 15. FIGS. 5 and 6 show a construction where the turbines 15 are held between a lower structure of rods or pipes 22 and then an upper structure formed by rods or pipes 23 so that the turbines 15 are held between the rods or pipes 22 and the rods or pipes 23. The construction of FIGS. 5 and 6 have a single hull 11, a motor 20, a battery (not shown) and optionally wheels 24 which maybe fixed or retractable.

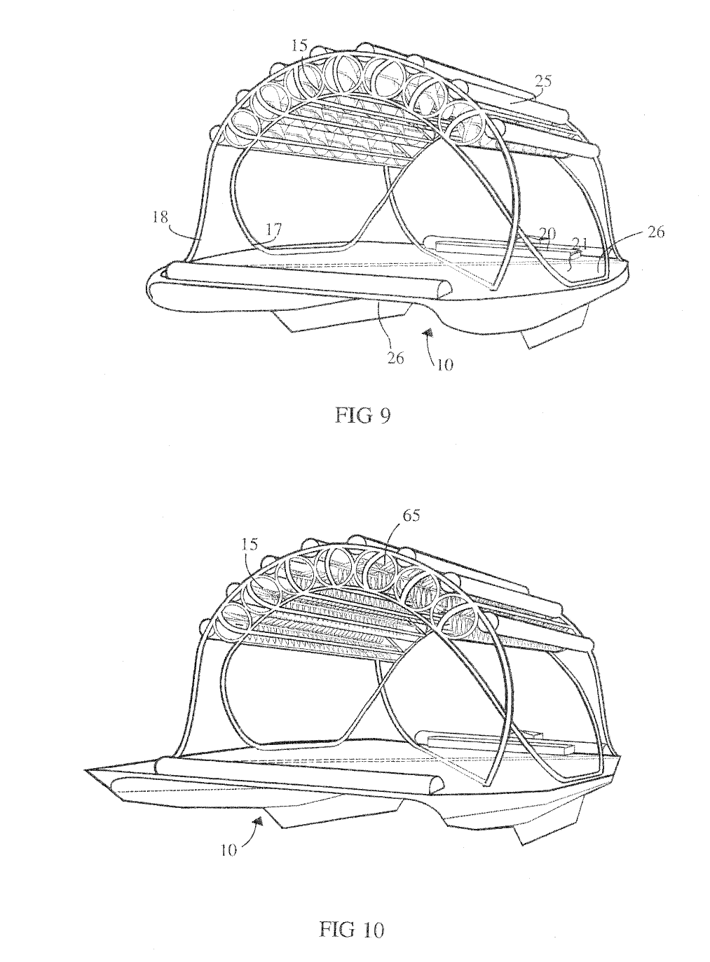

FIGS. 7 to 9 show a construction having seven turbines.

In the preferred form of the invention the outer frame 23 also carries buoyant pontoons 25 which will assist in righting the vessel should it overturn in water.

Transverse pontoons 26 may also be provided for example adjacent the bow and aft of the vessel.

A suitable steerable rudder 28 is also desirably provided.

Anchors could be provided at points 30 which may be of conventional type.

The batteries 21 may be deep cycle sealed lead acid batteries or similar and the motor 20 may be an electric permanent magnet motor of a type currently used on sail boats or could be a hovercraft propulsion system, or indeed could be any other suitable propulsion system.

The exoskeleton may be constructed by any suitable materials which can be traditional materials such as metal tube or could be from a range of materials from bamboo to plastic, carbon fibre or the like so as to reduce the weight.

The anchors 30 are desirably retractable and provided at the four corners of the vessel.

The construction of FIG. 10 is similar to the structure of FIGS. 7 to 9 save that a bladed turbine 15 is shown rather than helical coils.

The construction of FIG. 11 is again similar but a protective structure 40 is provided so as to enable the construction to be used as a houseboat.

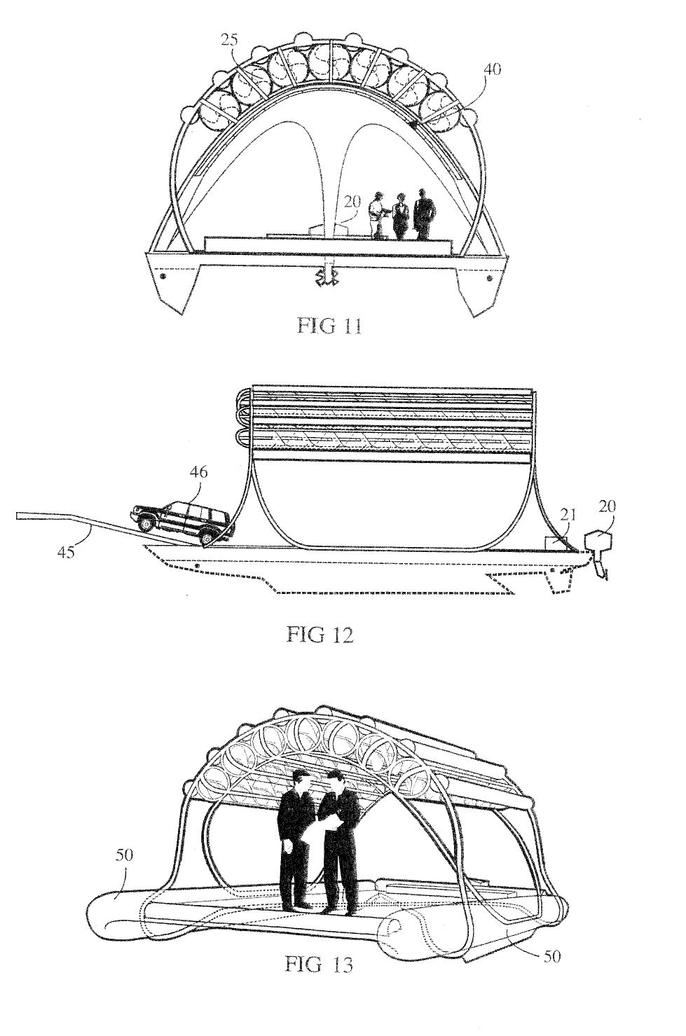

The construction of FIG. 12 shows use as a car ferry where a suitable ramp 45 is provided to allow a vehicle 46 and others of course to be entered to or from the ferry described.

In the construction of FIG. 13 the vehicle is substantially similar but shows inflatable hulls 50. This construction also used as a self propelled generator.

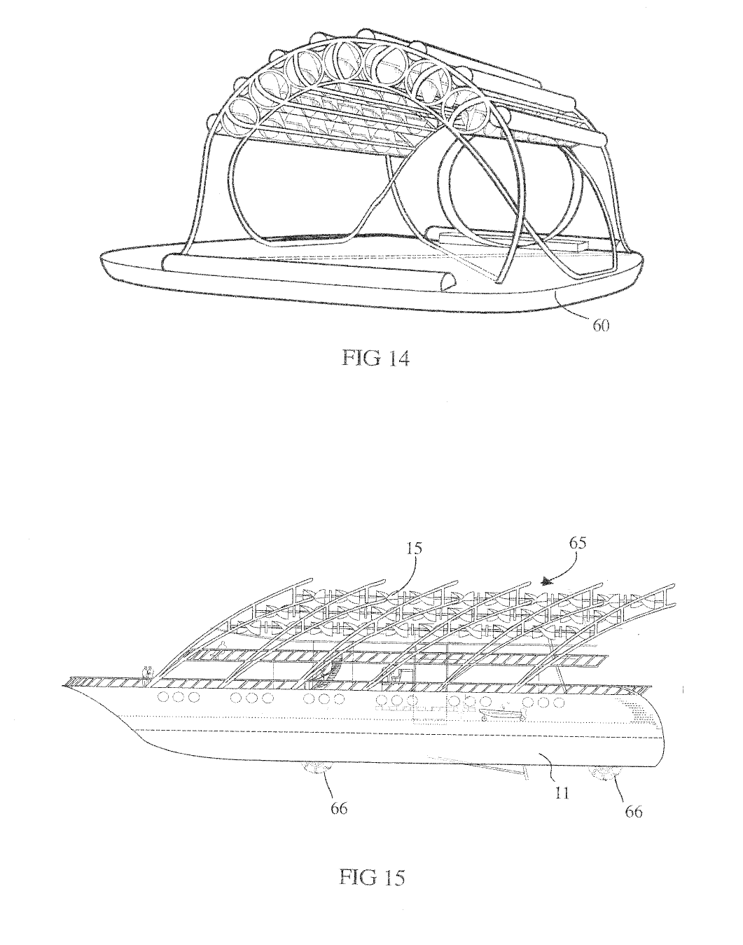

In the embodiment of FIG. 14 the deck or platform and hulls have been replaced by an alternative base 60 which is substantially in the form of a hovercraft base so that the construction can operate as a hovercraft.

Motors for forward propulsion and for generating air pressure within the hull 60 are provided to allow the hovercraft propulsion in, for example, substantially the known manner.

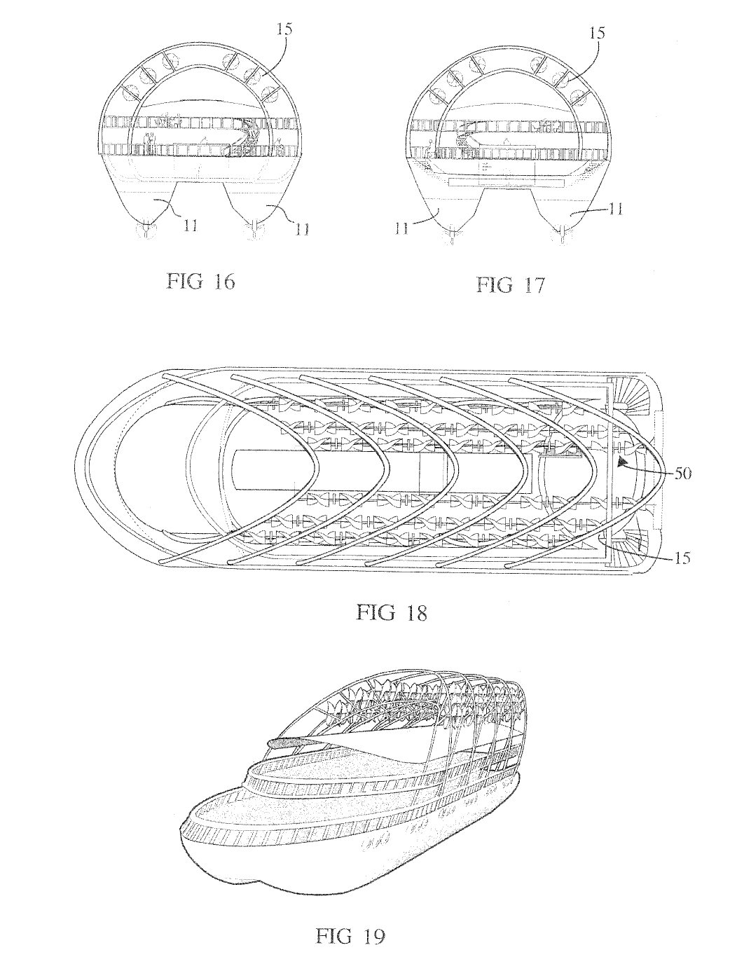

FIGS. 15 to 18 show a substantially longer marine vessel utilising banks of turbines 15. The hulls 11 again provide a catamaran configuration. The construction optionally has wheels 66.

The construction of FIG. 19 the vessel is shown as a transportable barge 55 of sufficient dimensions to enable the platform or deck 12 to be used, for example manufacturing wind turbines. The barge can be moored at a quay side 56 so as to be approachable by sea going vessels 57 on the opposite side.

In use the turbines are used to generate electrical power by the passage of wind through the exoskeleton vehicle which is readily achievable as the turbines are mounted substantially horizontally in use.

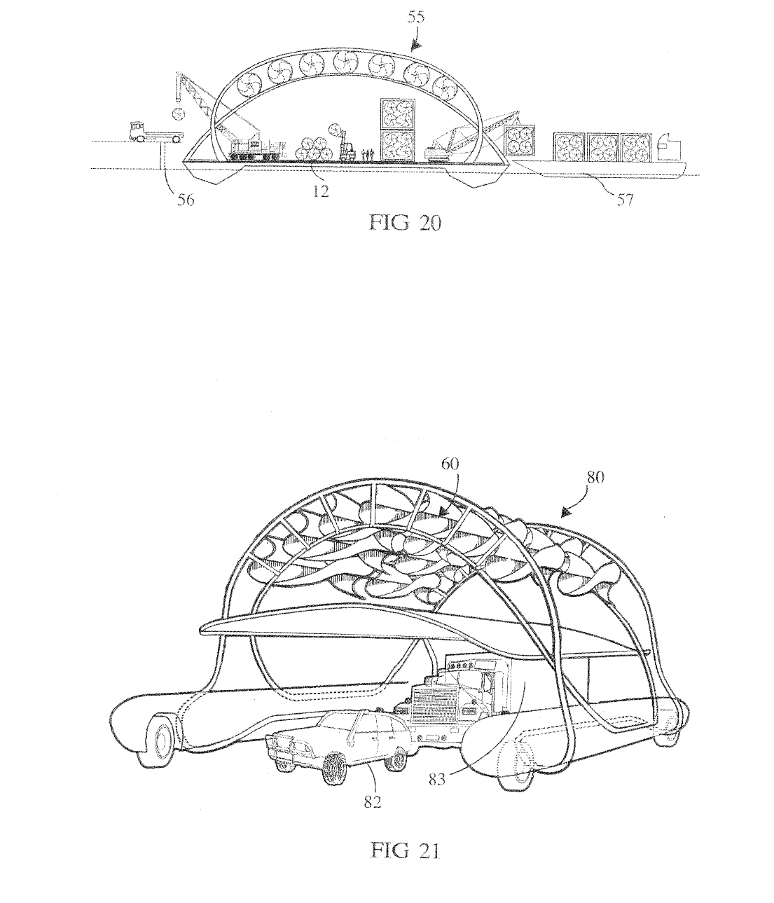

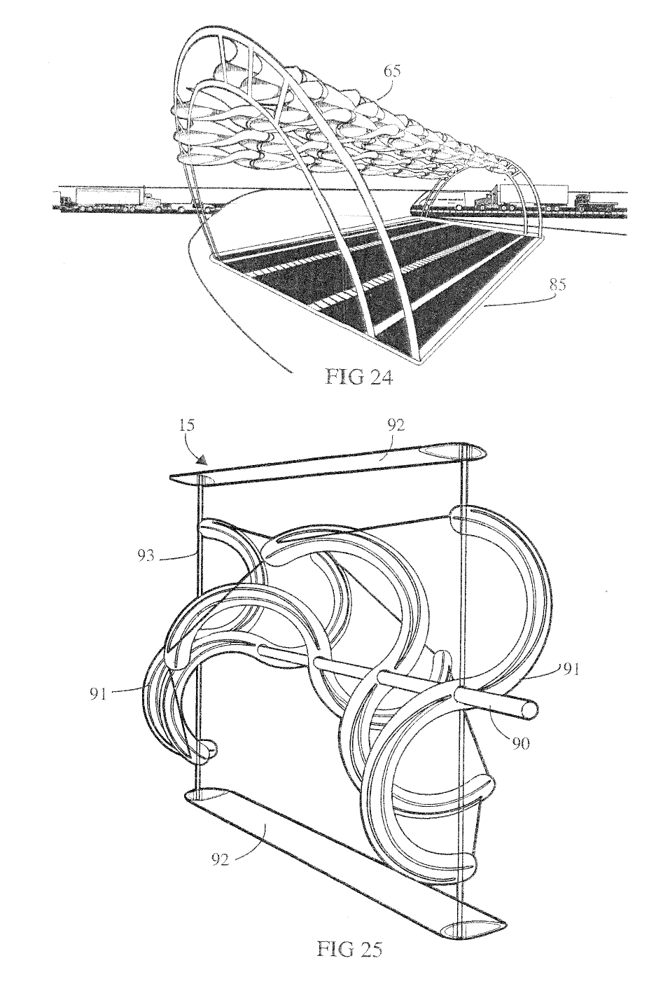

FIGS. 20 to 22 show moveable devices 80 and 81 which carry a turbine array 60 able to charge batteries (not shown). Vehicles such as cars 82 and trucks 83 may park adjacent the device for recharging of batteries, thus making the use of electrical vehicles more practical as recharging stations can be made widely available. In FIG. 23 boats 83 can be recharged in a similar manner. In these embodiments the device is in effect a readily moveable generator and the movement allows best use to be made of the wind.

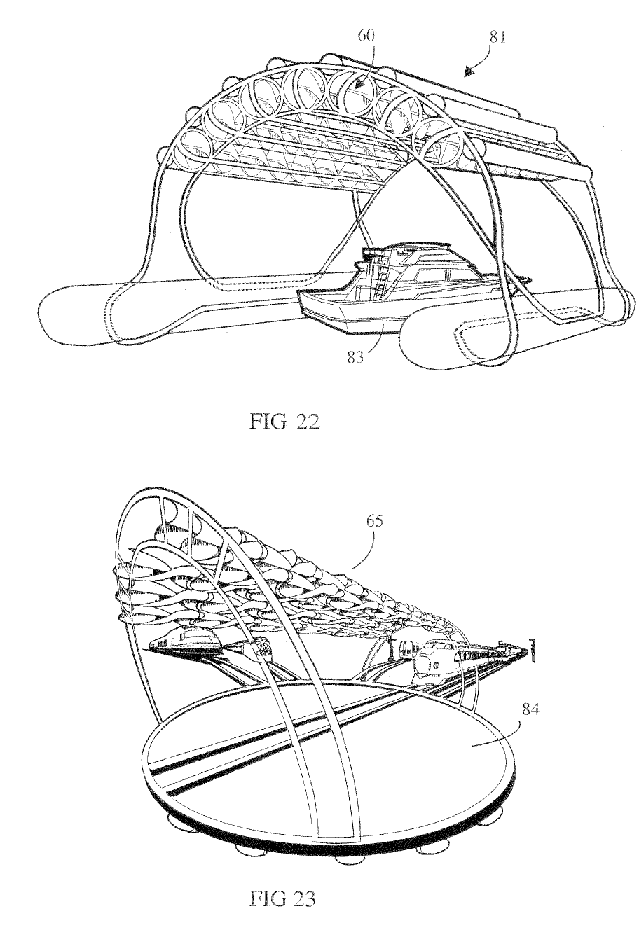

FIG. 22 shows a railway turntable 84 the motive power for which is derived from turbine array 65, and FIG. 24 shows a swingbridge 85 that motive power for which also derives from a turbine array 65.

The construction of FIGS. 22 to 24 may also be moved when not in use to the direction of maximum output of the turbines having regard in particular to wind direction.

FIG. 25 shows a turbine 15 mounted on axle 90.

The axle 90 mounts substantially “s” shaped blades 91 substantially transverse to axle 90 and aerofoil sections 92 substantially longitudinally parallel to axle 90. The aerofoil sections 92 are mounted on the axle 90 by means of rods 93 inserted transversely through the axle 90.

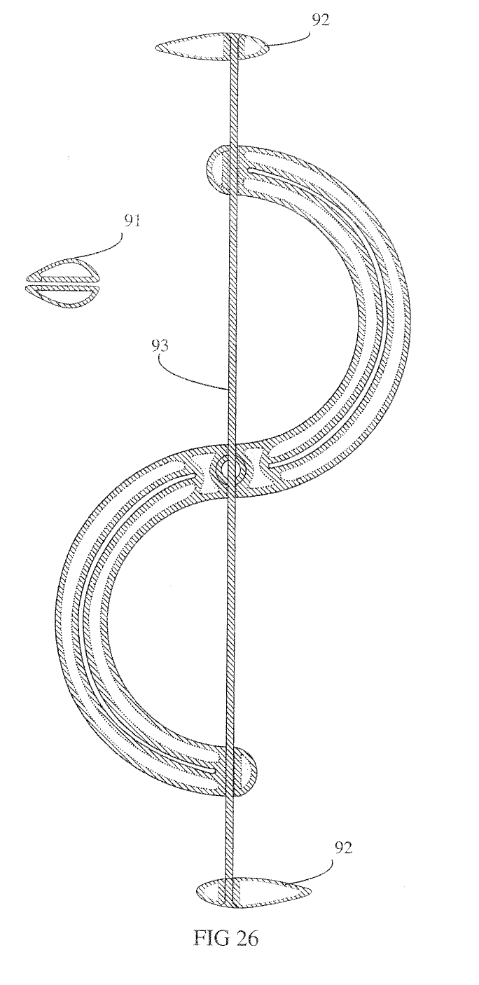

FIG. 26 shows a construction where blades 91 themselves are of an aerofoil section as well as the sections 92. A turbine useful in the invention as described in U.S. Pat. No. 7,132,760. However any turbine which operates largely independently of wind direction can be used. Thus the turbines operate at least over a wide range of wind directions.

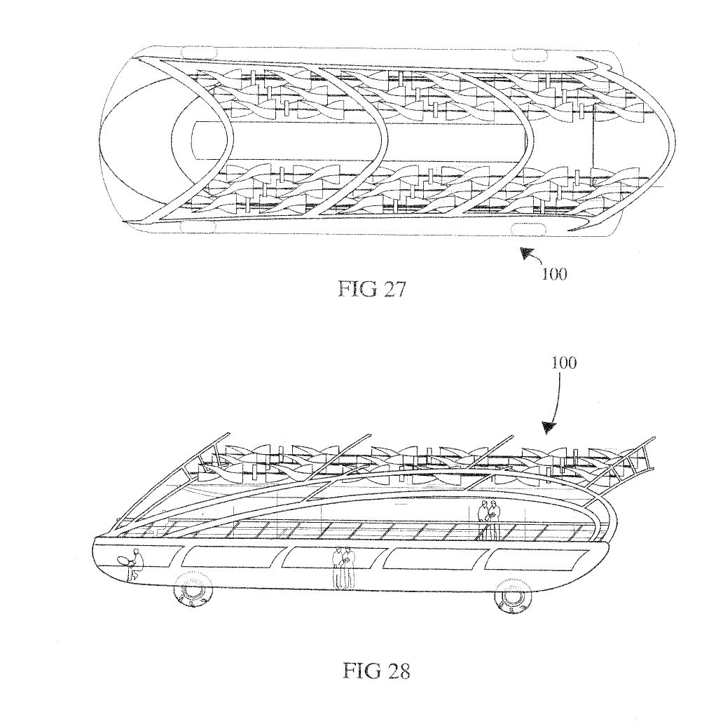

FIGS. 27 and 28 show a land traversing vehicle 100 mounting a turbine set 15. Wheels 101 are provided suitable for traversing the land surfaces, such as along a road.

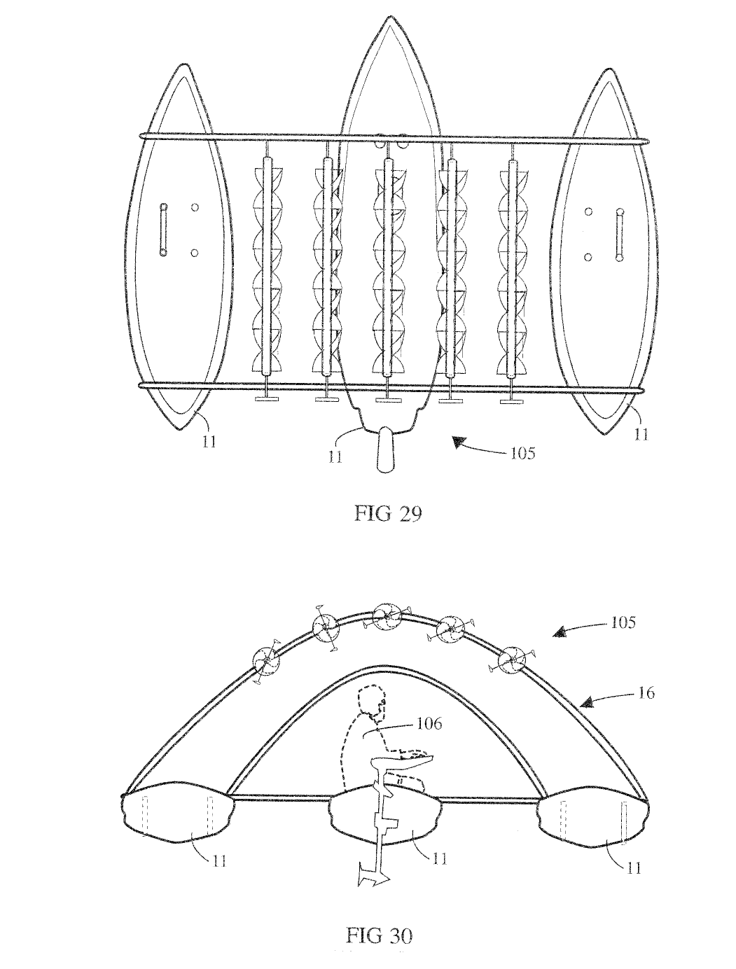

FIGS. 29 and 30 show a tri-maran version of the catamaran of FIGS. 7 and 8. The vehicle 105 mounts turbines 15 on to interconnected hulls 11. The exoskeleton 16 provides space for a user 106 to sit therebelow on the central hull 11.

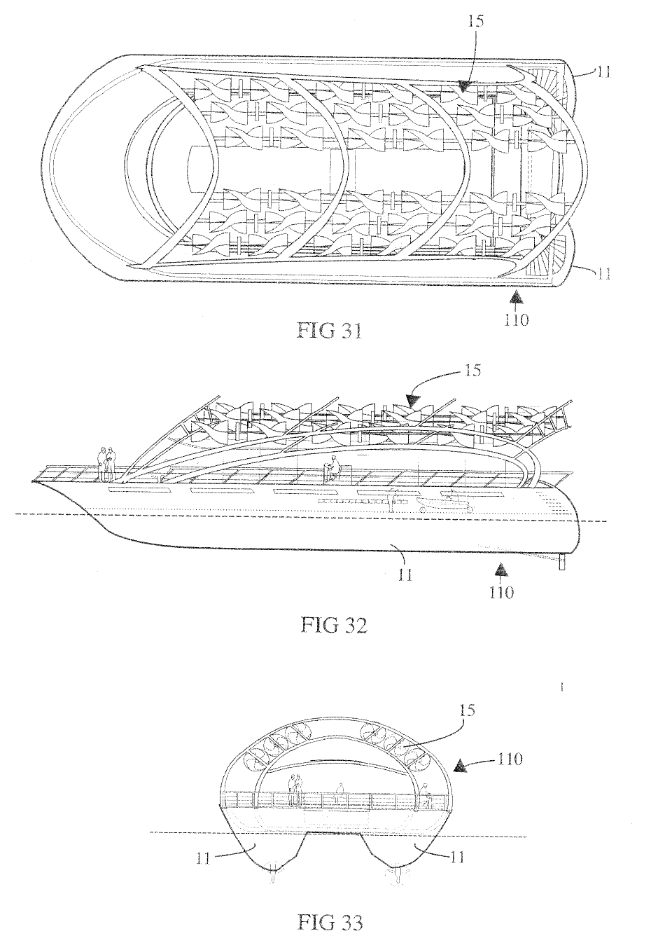

FIGS. 31 to 33 show a marine vessel 110 in catamaran form being similar to the construction of FIGS. 15 to 19 but without wheels. The construction is intended to be usable as a mobile home.

The electrical power generated is stored in a battery which can then be used to drive motors.

Thus it can be seen that at least in the preferred form of the invention a vehicle in particular and marine vessel is provided which does not use non-fixed means such as sails for manoeuvring so as to substantially free the operators for other purposes.

The advantages of and the economy of renewal wind power are however preserved. The construction provides a robust, easy to operate vessel using wind energy. Any excess energy can also be stored or used to power lights and equipment on board the vessel. The absence of winches and lines gives the advantage of having clear decks and reducing the weight of the vessel. The vessel is also easy to operate.

The use of the exoskeleton places the turbines away from the base which is better structurally, cuts down on interference to wind and also provides a useable space between the base and turbines which can be made appropriate to the use as can be seen from the drawings. The turbines are also held as far away from each other as possible. The turbines can operate on both fair wind and true wind.

In the preferred embodiment the pontoons are provided which will give a self righting mechanism in the event of the vessel turning over. The vessel is however stable.

The pontoons could be deflatable when speed is required or have luminescent material to add navigational safety.

The vessel can be scaled to a desirable size for use in a wide variety of applications such as generator, life raft, pleasure craft, house boat, barge or ferry.

The exoskeleton which mounts the turbines and pontoons contributes to the stability of the vessel and also provides a frame work for either fixed or removeable protective covering for the operator and or occupants.

The helical or helicoidal turbines will operate with wind from any direction and can be scaled up for larger vessels when necessary. Alternatively the design can be altered to include more turbines, either in the array disclosed here or for example an additional array to the rear for a longer craft or by providing banks of turbines.

The turbines have the advantage that they provide a relatively silent zero emission low maintenance clean environment.

The ability to generate excess power opens the way for use of a wide range of conventional electric marine devices for accommodation, lighting, safety and navigation, which would be less economic for current fuel powered crafts.

Also as can be seen the principles developed for marine vessels are capable of use in a wider variety of situations.

1-31. (canceled)

32. A device capable of translational movement having a base capable of movement across a ground surface or across or through a liquid surface, said base mounting one or more wind turbines aligned substantially horizontally in use, and drive means operable to move said base, the drive means being powered directly or indirectly by said turbine or turbines, the turbine(s) being such that the turbine operates over at least a wide range of winds directions relative to the device.

33. A device as claimed in claim 32 wherein said turbines are spaced outwardly in use from the said base.

34. A device as claimed in claim 32 wherein said turbines provide electric power to a battery, the battery driving an electrically powered motor.

35. A device as claimed in claim 32 wherein the turbines are mounted on an exoskeleton mounted above said hull or hulls.

36. A device as claimed in claim 35 wherein the exoskeleton is shaped substantially in the form of a half cylinder.

37. A device as claimed in claim 32 wherein the device comprises a vehicle.

38. A device as claimed in claim 37 wherein said vehicle comprises a vessel.

39. A device as claimed in claim 38 wherein said vessel comprises a marine vessel.

40. A device as claimed in claim 32 wherein a plurality of turbines are mounted above the base.

41. A device as claimed in claim 32 wherein said turbines are helical or helicoidal.

42. A device as claimed in claim 32 wherein said turbines are propeller driven.

43. A device as claimed in claim 32 wherein said base comprises a hull or hulls.

44. A device as claimed in claim 42 wherein there are two or three hulls.

45. A device as claimed in claim 43 wherein pontoons are provided exterior of said turbines with respect to the hull or hulls to provide buoyancy in the event of the device overturning.

46. A device as claimed in claim 45 wherein the pontoons are provided across the hull or hulls adjacent fore and aft positions of the device.

47. A device as claimed in claim 32 wherein the base carries wheels to allow operation on land surfaces.

48. A device capable of translational movement having a base capable of movement across a ground surface or across or through a liquid surface, said base mounting one or more wind turbines aligned substantially horizontally in use, and drive means operable to move said base, the drive means being powered directly or indirectly by said turbine or turbines, the turbine(s) being spaced outwardly from the base so as to provide usable space between the turbine or turbines and the base.

49. A device as claimed in claim 48 wherein said turbines provide electric power to a battery, the battery driving an electrically powered motor.

50. A device as claimed in claim 48 wherein the turbines are mounted on an exoskeleton mounted above said hull or hulls.

51. A device as claimed in claim 50 wherein the exoskeleton is shaped substantially in the form a half cylinder.
